(19) United States
(12) Patent Application Publication
(10) Pub. No.: US 2017/0257555 A1
(43) Pub. Date: Sep. 7, 2017

(54) FOCUSING METHOD AND FOCUSING SYSTEM BASED ON A DISTANCE SENSOR OF MOBILE TERMINAL

(71) Applicant: HUIZHOU TCL MOBILE COMMUNICATION CO., LTD., Huizhou City (CN)

(72) Inventor: Wenyuan Li, Huizhou (CN)

(73) Assignee: Huizhou Tcl Mobile Communication Co., Ltd.

(21) Appl. No.: 15/308,600

(22) PCT Filed: Oct. 30, 2015
(86) PCT No.: PCT/CN2015/093338

§ 371 Date: May 24, 2017

(30) Foreign Application Priority Data
Apr. 27, 2015 (CN) 201510203711.3

(51) Int. Cl. H04N 5/232; G02B 7/28; G02B 7/38

(52) U.S. Cl. CPC H04N 5/23212; G02B 7/38; G02B 7/285

(57) ABSTRACT

A focusing method and a focusing system based on a distance sensor of mobile terminal is provided. The method may include: acquiring an initial distance between a camera and an object to be shot by using the distance sensor; judging whether the distance between the camera and the object changed; in response to judging that the distance changed, acquiring a micro-adjustment range of a motor according to the distance; controlling the motor to move based on the micro-adjustment ranges; collecting images from the camera in a real-time manner; acquiring focus values of the collected images; and moving the motor to a position corresponding to a largest focus value of the focus values to focus the camera.

### TECHNICAL FIELD

The present disclosure relates to the technical field of mobile terminal. In particular, the present disclosure relates to a focusing method and focusing system based on a distance sensor of a mobile terminal.

### BACKGROUND

With the development of mobile communication and continuous improvement of the people's living standards, various mobile terminals (such as cell phones) have become more and more popular, and cell phones have become an indispensable communication tool in people's lives.

With a conventional focusing algorithm for a mobile phone camera, the focus values (FV) of images of a motor at different positions are acquired by continuously moving the motor to judge the definition of images. After scanning, the best motor position is judged, and then the motor is moved to the clearest position, so as to finish a focusing action. In the whole process, the frame rate is 0.5-2 seconds at different times, depending on the search range. Particularly in dark places where light is inadequate, the exposure time of the mobile phone will be increased accordingly, which reduces the frame rate and increases the focusing time. The delay is very likely to result in the photographer's inability to capture “splendid moments.”

Focusing usually requires scanning the whole focusing range to find the clearest point. As the whole search range is large, it is usually required to use a plurality of frames to pick out the clearest image. In a dark environment, which results in a long exposure time and a low frame rate, the focusing time will be delayed to several seconds. Sometimes, the final focusing will fail as the images are not bright enough or the algorithm itself has defects. Furthermore, focusing realized just by software algorithms cannot judge whether the position of the object with respect to the camera changes, and repeated focusing or no focusing occurs after movement of the object.

Therefore, there is a need for an improved method of focusing for cameras on mobile terminals, such as cell phones.

### SUMMARY

In light of the deficiencies of the prior art, a focusing method and focusing system based on a distance sensor of a mobile terminal is described. Advantageously, the proposed focusing method and system may avoid delayed shooting time due to a long focusing time or repeated focusing during shooting.

A focusing method based on a distance sensor of mobile terminal includes:
acquiring and storing an initial distance between a camera and an object to be shot by using the distance sensor after detecting that a shooting function of the mobile terminal has started;
judging whether a current distance acquired by the distance sensor is equal to the initial distance;
in response to the judging that the current distance is not equal to the initial distance, querying a correspondence table to acquire a target micro-adjustment range of the motor according to the current distance, controlling the motor to move within the target micro-adjustment range, and collecting images from the camera; and
acquiring focus values of the images when the motor moves into different positions within the target micro-adjustment range, and controlling the motor to move to a position corresponding to a largest focus value of the focus values, thereby focusing the camera.

In another embodiment, a focusing method based on a distance sensor of a mobile terminal includes, prior to the judging:
presetting and storing the correspondence table of distances between the distance sensor and the object to be shot and associated micro-adjustment ranges of the motor.

In a further embodiment, a focusing method based on a distance sensor of a mobile terminal includes:
controlling the motor to keep still at a current position in response to the judging that the current distance is equal to the initial distance.

In yet a further embodiment, a focusing method based on a distance sensor of a mobile terminal includes the collecting of the images is in a real-time manner.

In yet a further embodiment, a focusing method based on a distance sensor of a mobile terminal includes the acquiring of the focus values of the images including:
acquiring and storing the focus values of the images when the motor moves into the different positions within the target micro-adjustment range;
comparing all of the focus values, and acquiring the position corresponding to the largest focus value; and

controlling the motor to move to the position corresponding to the largest focus value of the focus values, thereby focusing the camera.

In another embodiment, a focusing system based on a distance sensor of a mobile terminal includes:
a detection and acquisition module acquiring and storing an initial distance between a camera and the object to be shot by using the distance sensor after detecting that a shooting function of the mobile terminal has started;
a judgment module judging whether a current distance acquired by the distance sensor is equal to the initial distance;
in response to the judgment module judging that the current distance is not equal to the initial distance, a query and image collection module querying a correspondence table to acquire the target micro-adjustment range of a motor according to the current distance, controlling the motor to move within the target micro-adjustment range, and collecting images from the camera; and
an acquisition and control module acquiring focus values of the images when the motor moves into different positions within the target micro-adjustment range, and controlling the motor to move to a position corresponding to a largest focus value of the focus values, thereby focusing the camera.

In a further embodiment, a focusing system based on a distance sensor of a mobile terminal includes:
a presetting and storage module presetting and storing the correspondence table of distances between the distance sensor and the object to be shot and associated micro-adjustment ranges of the motor.

In yet a further embodiment, a focusing system based on a distance sensor of a mobile terminal, wherein the judgment module includes:
a judgment and control unit controlling the motor to keep still at a current position in response to the judging that the current distance is equal to the initial distance.

In yet a further embodiment, a focusing system based on a distance sensor of a mobile terminal includes the query and image collection module including:
a detection and acquisition unit for acquiring the current distance between the distance sensor and the object to be shot in response to judging that the current distance has changed;
a query unit querying the correspondence table to acquire the target micro-adjustment range of the motor according to the current distance; and
a control and collection unit for controlling the motor to move within the target micro-adjustment range, and collecting images from the camera.

In yet a further embodiment, a focusing system based on a distance sensor of a mobile terminal includes the acquisition and control module including:
an acquisition and storage unit acquiring and storing the focus values of the images when the motor moves into the different positions within the target micro-adjustment range;
a comparison unit comparing all of the focus values, and acquiring the position corresponding to the largest focus value of the focus values; and
a control unit controlling the motor to move to a position corresponding to a largest focus value of the focus values, thereby focusing the camera.

In another embodiment, a storage medium storing a processor-executable instruction therein, wherein the processor-executable instruction is configured to cause, when executed by a processor: acquiring and storing an initial distance between a camera and the object to be shot by using the distance sensor after detecting that a shooting function of the mobile terminal has started;
judging whether a current distance acquired by the distance sensor is equal to the initial distance;
in response to the judging that the current distance is not equal to the initial distance, querying the correspondence table to acquire the target micro-adjustment range of the motor according to the current distance, controlling the motor to move within the target micro-adjustment range, and collecting images from the camera; and
acquiring focus values of the images when the motor moves into different positions within the target micro-adjustment range, and controlling the motor to move to a position corresponding to a largest focus value of the focus values, thereby focusing the camera.

In a further embodiment, a storage medium, wherein a processor-executable instruction is further configured to cause, prior to the judging:
presetting and storing the correspondence table of distances between the distance sensor and the object to be shot and associated micro-adjustment ranges of the motor.

In yet a further embodiment, a storage medium, wherein a processor-executable instruction is further configured to cause:
controlling the motor to keep still at a current position in response to the judging that the current distance is equal to the initial distance.

In yet a further embodiment, a storage medium, wherein a processor-executable instruction is further configured to cause the collecting of the images in a real-time manner.

In yet a further embodiment, a storage medium, wherein a processor-executable instruction is further configured so that the acquiring of the focus values includes:
acquiring and storing the focus values of the images when the motor moves into the different positions within the target micro-adjustment range;
comparing all of the focus values, and acquiring the position corresponding to the largest focus value; and
controlling the motor to move to the position corresponding to the largest focus value of the focus values, thereby focusing the camera.

A focusing method and focusing system based on a distance sensor of a mobile terminal may thus include: acquiring an initial distance between a camera and an object to be shot by using the distance sensor; judging whether the distance between the camera and the object changed; in response to judging that the distance changed, acquiring a micro-adjustment range of a motor according to the distance; controlling the motor to move based on the micro-adjustment range; collecting images from the camera in a real-time manner; acquiring focus values of the collected images; and moving the motor to a position corresponding to a largest focus value of the focus values to focus the camera. Accordingly, refocusing can be avoided when the object remains still relative to the camera, whereas relative movement of the object will immediately trigger focusing. Furthermore, as the focusing micro-adjustment range has been set at the debugging stage and a large-scale search of the focusing table is not required, the best focal length can be found only by comparing 0-3 frames to finish focusing, which increases focusing speed and facilitates users to take photos.

### BRIEF DESCRIPTION OF THE DRAWINGS

FIG. 1 depicts a flowchart of a focusing method based on a distance sensor of a mobile terminal, according to an exemplary embodiment of the present invention.

FIG. 2 depicts a schematic diagram of a correspondence table between positions of a distance sensor and micro-adjustment ranges of a motor, according to an exemplary embodiment of the present invention.

FIG. 3 depicts a flowchart of a focusing method based on a distance sensor of a mobile terminal, according to an exemplary embodiment of the present invention.

FIG. 4 depicts a functional block diagram flowchart of a focusing system based on a distance sensor of a mobile terminal, according to an exemplary embodiment of the present invention.

### DETAILED DESCRIPTION

In order to make the purpose, technical solutions and advantages of the present invention more clear, the invention is described in detail in combination with accompanied figures and exemplary embodiments. It should be understood that exemplary embodiments described herein are for illustrative purposes only. The exemplary embodiments are not intended to limit the scope of the claimed invention in any way.

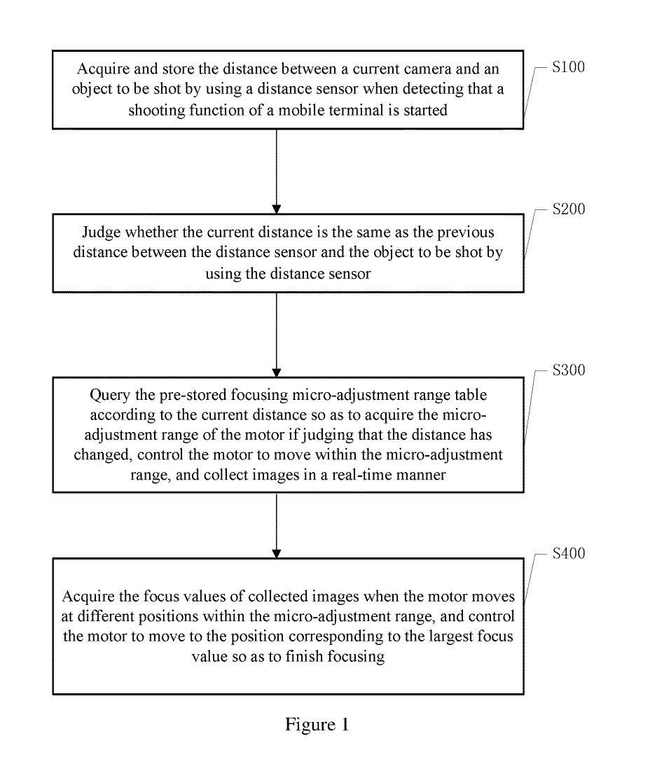

Turning to FIG. 1, FIG. 1 depicts a flowchart of a focusing method based on a distance sensor of a mobile terminal, according to an exemplary embodiment of the present invention. The method may include:
acquiring and storing an initial distance between a camera and an object to be shot by using the distance sensor after detecting that a shooting function of the mobile terminal has started. (block S100)

In an example, a distance sensor is introduced into a mobile terminal, with the distance sensor in the same plane with an image sensor so that both the distance sensor and the image sensor have the same distance from an object. A new drive device is pre-registered for a mobile terminal. In this example, a drive distance sensor is pre-registered in a system by using a Linux operating system to add a new device by matching the driver device through a bus. Therefore, the device is registered to be a misc. device on the iic bus. The specific method is ret=i2c_add_driver(&stmvl6180_driver); i2c_register_board_info(1, &i2c_stmvl6180, 1) in probe, so that stmv6180 device is registered in the iic bus. The device is registered when the bus is subject to probe (misc_register(&stmvl6180_ranging_dev), which prepares for an algorithm to acquire distance information in the future.

One specific method for acquiring distance is as follows: opening the newly-registered device through device node, and acquiring the current distance information through ioctl. For example: UCHAR cBuf[128]=“/dev/stmvl6180”; ISTMV6180=open(cBuf, O_RDWR); acquiring distance information: ioctlerr=ioctl(ISTMV6180_HANDLE,VL6180_IOCTL_GETDATA, &distance); and acquiring real-time distance information through the working focusing algorithm described above.

The distance sensor is installed at the position parallel to the image sensor and is provided with a laser transmitter and a laser receiver. An infrared transmitter (if used) will transmit a laser beam, and the current distance is calculated through the distance between the transmitting position and the receiving position and is stored.

The method may further include, prior to S100:
presetting and storing the correspondence table of distances between the distance sensor and the object to be shot and associated micro-adjustment ranges of the motor. (Block S1)

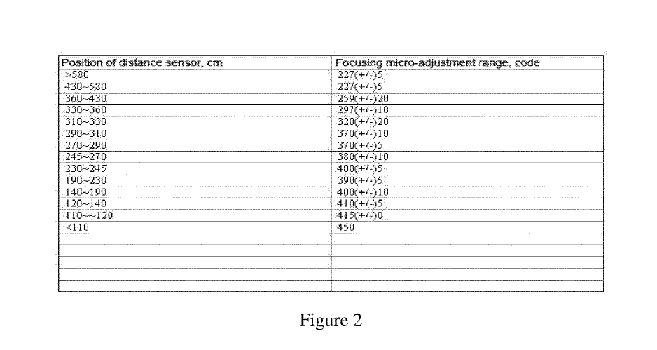

An example of the distances between the distance sensor and the object to be shot and the correspondence table of the focusing micro adjustment ranges of the motor is depicted in FIG. 2: when the distance between the distance sensor and the object exceeds 580 cm, the focusing micro-adjustment range is within 227 (+/−) 5code. When the distance between the distance sensor and the object is less than 110 cm, the focusing micro-adjustment range is 450code. Specifically, code is generally used as a unit which is a ratio value, a 10-digit dac current ratio ranging from 0 to 1023 (0 corresponding to 0 in all 10 binary digits, and 1023 corresponding to 1 in all 10 binary digits. In an example, the maximum operating current of a motor is 100 mA, and the focusing micro-adjustment range being 227 means that the motor current is 100 ma*227/1024=22.16 mA, thus 227+/−5 is 22.16+/−1.11 mA. Of course, different motors have different drive current, other motors may have the maximum current of 120 mA, based on which, the current calculation will be different. Thus, the motor is driven by the adjusting the drive current thereof.

The method may further include:
judging whether a current distance acquired by the distance sensor is equal to the initial distance. (block S200)

In an example, block S200 further includes:
controlling the motor to keep still at a current position in response to the judging that the current distance is equal to the initial distance. (block S201)

Thus, the method may include acquiring the current distance with an object by using the distance sensor, comparing it with the object distance stored previously and judging whether the distance has changed; if the distance with the object to be shot does not change, directly taking photos with the original position of the motor, which saves time by avoiding a refocusing.

The method may further include:
in response to the judging that the current distance is not equal to the initial distance, querying a correspondence table to acquire a target micro-adjustment range of the motor according to the current distance, controlling the motor to move within the target micro-adjustment range, and collecting images from the camera. (block S300)

In an example, block S300 includes:
acquiring the current distance between the distance sensor and the object to be shot in response to judging that the current distance has changed; (block S301)
querying the correspondence table to acquire the target micro-adjustment range of the motor according to the current distance; and
controlling the motor to move within the target micro-adjustment range, and collecting images from the camera in a real-time manner.

In an example, when detecting that the current distance has changed, the method includes acquiring the current distance (230 cm, for example) between the current distance sensor and the object to be shot; querying the table as shown in FIG. 2 to acquire the focusing micro-adjustment range (400 (+/−) 5code) of the motor, that is the focusing micro-adjustment range of the motor is range 395-405code; controlling the motor to move within range 395-405code, collecting images of the motor moving at different positions in a real-time manner and storing the images.

The method may further include:
acquiring focus values of the images when the motor moves into different positions within the target micro-adjustment range, and controlling the motor to move to a position corresponding to a largest focus value of the focus values, thereby focusing the camera. (block S400)

In an example, block S400 includes:
acquiring and storing the focus values of the images when the motor moves into the different positions within the target micro-adjustment range; (block S401)
comparing all of the focus values, and acquiring the position corresponding to the largest focus value; (block S402) and
controlling the motor to move to the position corresponding to the largest focus value of the focus values, thereby focusing the camera. (block S403)

In an example, when the motor moves within the micro-adjustment range, the method includes acquiring the focus values of the images of the motor at different positions, that is FV; judging whether the current FV is the position corresponding to the largest FV; and acquiring the specific FV by a set focusing algorithm (the larger the FV is, the clearer an image is). After acquiring the position corresponding to the largest focus value, the method includes moving the motor to the position corresponding to the largest focus value to finish focusing. If photos are taken at this time, photos with the best quality can be acquired.

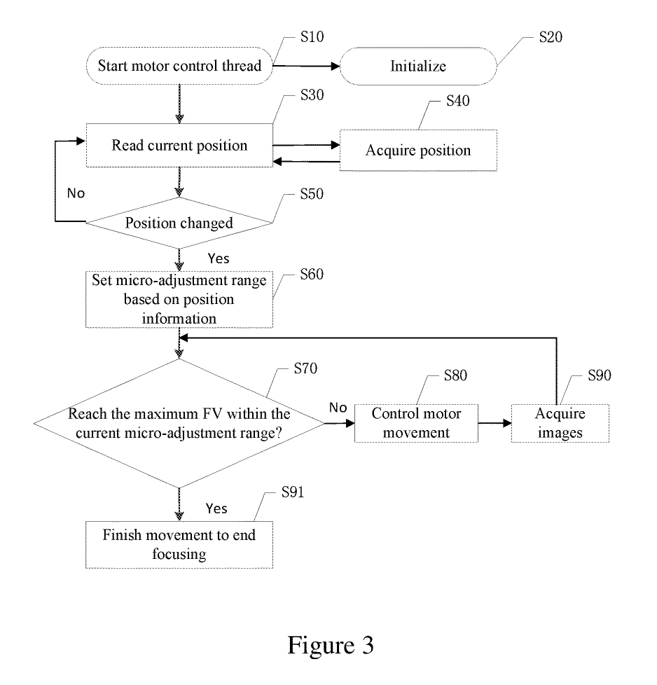

In an example of a focusing method based on a distance sensor of a mobile terminal (see FIG. 3), and the method comprises:
starting a control thread of a motor (block S10)
initializing the motor; (block S20)
reading the current position information, (block S30)
acquiring position (block S40)
judging whether the position changes; (block S50) if yes, proceed to block S60; if not, proceed to block S30;
setting a micro-adjustment range based on the position information, (block S60)
judging whether the largest FV is reached in the current micro-adjustment range; (block S70) if yes, proceed to block S91; if not, proceed to block S80;
controlling the motor to move, (block S80)
acquiring images; (block S90) and
moving to finish focusing. (block S91)

According to the examples described above, the invention provides a focusing method based on a distance sensor of a mobile terminal, which includes judging whether a distance between a camera and an object changes. If the distance has not changed, the current motor position is kept without adjustment. If the distance has changed, a preset micro-adjustment range is found according to the current position, a movement of the motor within the micro-adjustment range is controlled, and an image of the current position is acquired to get the current FV. The largest FV distance is acquired in the FV values within micro-adjustment range to finish focusing, which increases the focusing speed of the shooting process.

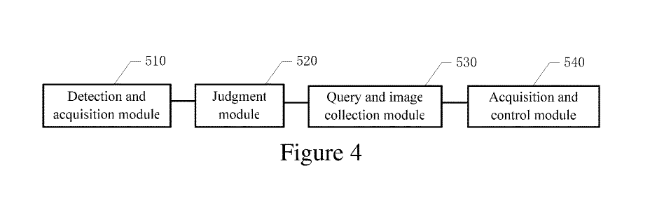

Based on the examples above, a focusing system based on distance terminal of a mobile terminal is also provided (see FIG. 4), which may include:
a detection and acquisition module 510 acquiring and storing an initial distance between a camera and the object to be shot by using the distance sensor after detecting that a shooting function of the mobile terminal has started (see description above for details);
a judging module 520 judging whether a current distance acquired by the distance sensor is equal to the initial distance (see description above for details);
in response to the judgment module judging that the current distance is not equal to the initial distance, a query and image collection module 530 querying a correspondence table to acquire the target micro-adjustment range of a motor according to the current distance, controlling the motor to move within the target micro-adjustment range, and collecting images from the camera (see description above for details); and
an acquisition and control module acquiring focus values of the images when the motor moves into different positions within the target micro-adjustment range, and controlling the motor to move to a position corresponding to a largest focus value of the focus values, thereby focusing the camera (see description above for details).

In an example, the focusing system may further include:
a presetting and storage module presetting and storing the correspondence table of distances between the distance sensor and the object to be shot and associated micro-adjustment ranges of the motor (see description above for details).

In an example, the judgment module of the focusing system may include:
a judgment and control unit controlling the motor to keep still at a current position in response to the judging that the current distance is equal to the initial distance (see description above for details).

In an example, the query and image collection module of the focusing system may include:
a detection and acquisition unit for acquiring the current distance between the distance sensor and the object to be shot in response to judging that the current distance has changed (see description above for details);
a query unit querying the correspondence table to acquire the target micro-adjustment range of the motor according to the current distance (see description above for details); and
a control and collection unit for controlling the motor to move within the target micro-adjustment range, and collecting images from the camera (see description above for details).

In an example, the collecting of the images of the focusing system may be done in a real-time manner (see description above for details).

In conclusion, a focusing method and focusing system based on a distance sensor of a mobile terminal has been provided, which may include: acquiring and storing an initial distance between a camera and an object to be shot by using the distance sensor after detecting that a shooting function of the mobile terminal has started; judging whether a current distance acquired by the distance sensor is equal to the initial distance; in response to the judging that the current distance is not equal to the initial distance, querying a correspondence table to acquire a target micro-adjustment range of the motor according to the current distance, controlling the motor to move within the target micro-adjustment range, and collecting images from the camera; and acquiring focus values of the images when the motor moves into different positions within the target micro-adjustment range, and controlling the motor to move to a position corresponding to a largest focus value of the focus values, thereby focusing the camera. Accordingly, refocusing can be avoided when the object remains still relative to the camera, whereas relative movement of the object will immediately trigger focusing. Furthermore, as the focusing micro-adjustment range has been set at the debugging stage and a large-scale search of the focusing table is not required, the best focal length can be found only by comparing 0-3 frames to finish focusing, which increases focusing speed and facilitates users to take photos. It should be understood that the application of the present invention is not limited to the examples above. Those skilled in the art can improve or change the invention based on the descriptions above, and the improvement and changes shall fall within the protection scope of the appended claims.

1-4. (canceled)

5. A focusing method based on a distance sensor of a mobile terminal, comprising:
acquiring and storing an initial distance between a camera and an object to be shot by using the distance sensor after detecting that a shooting function of the mobile terminal has started;
judging whether a current distance acquired by the distance sensor is equal to the initial distance;
in response to the judging that the current distance is not equal to the initial distance, querying a correspondence table to acquire a target micro-adjustment range of the motor according to the current distance, controlling the motor to move within the target micro-adjustment range, and collecting images from the camera; and
acquiring focus values of the images when the motor moves into different positions within the target micro-adjustment range, and controlling the motor to move to a position corresponding to a largest focus value of the focus values, thereby focusing the camera.

6. The method according to claim 5, wherein the method further comprises, prior to the judging:
presetting and storing the correspondence table of distances between the distance sensor and the object to be shot and associated micro-adjustment ranges of the motor.

7. The method according to claim 5, wherein the method further comprises:
controlling the motor to keep still at a current position in response to the judging that the current distance is equal to the initial distance.

8. The method according to claim 5, wherein the collecting of the images is in a real-time manner.

9. The method according to claim 5, wherein the acquiring of the focus values of the images comprises:
acquiring and storing the focus values of the images when the motor moves into the different positions within the target micro-adjustment range;
comparing all of the focus values, and acquiring the position corresponding to the largest focus value; and
controlling the motor to move to the position corresponding to the largest focus value of the focus values, thereby focusing the camera.

10. A focusing system based on a distance sensor of a mobile terminal, comprising:
a detection and acquisition module acquiring and storing an initial distance between a camera and the object to be shot by using the distance sensor after detecting that a shooting function of the mobile terminal has started;
a judgment module judging whether a current distance acquired by the distance sensor is equal to the initial distance;
in response to the judgment module judging that the current distance is not equal to the initial distance, a query and image collection module querying a correspondence table to acquire the target micro-adjustment range of a motor according to the current distance, controlling the motor to move within the target micro-adjustment range, and collecting images from the camera; and
an acquisition and control module acquiring focus values of the images when the motor moves into different positions within the target micro-adjustment range, and controlling the motor to move to a position corresponding to a largest focus value of the focus values, thereby focusing the camera.

11. The system according to claim 10, further comprising:
a presetting and storage module presetting and storing the correspondence table of distances between the distance sensor and the object to be shot and associated micro-adjustment ranges of the motor.

12. The system according to claim 10, wherein the judgment module further comprises:
a judgment and control unit controlling the motor to keep still at a current position in response to the judging that the current distance is equal to the initial distance.

13. The system according to claim 10, wherein the query and image collection module comprises:
a detection and acquisition unit for acquiring the current distance between the distance sensor and the object to be shot in response to judging that the current distance has changed;
a query unit querying the correspondence table to acquire the target micro-adjustment range of the motor according to the current distance; and
a control and collection unit for controlling the motor to move within the target micro-adjustment range, and collecting images from the camera.

14. The system according to claim 10, wherein the acquisition and control module comprises:
an acquisition and storage unit acquiring and storing the focus values of the images when the motor moves into the different positions within the target micro-adjustment range;
a comparison unit comparing all of the focus values, and acquiring the position corresponding to the largest focus value of the focus values; and
a control unit controlling the motor to move to a position corresponding to a largest focus value of the focus values, thereby focusing the camera.

15. A storage medium for storing a processor-executable instruction therein, wherein the processor-executable instruction is configured to cause, when executed by a processor:
acquiring and storing an initial distance between a camera and the object to be shot by using the distance sensor after detecting that a shooting function of the mobile terminal has started;
judging whether a current distance acquired by the distance sensor is equal to the initial distance;
in response to the judging that the current distance is not equal to the initial distance, querying the correspondence table to acquire the target micro-adjustment range of the motor according to the current distance, controlling the motor to move within the target micro-adjustment range, and collecting images from the camera; and
acquiring focus values of the images when the motor moves into different positions within the target micro-adjustment range, and controlling the motor to move to a position corresponding to a largest focus value of the focus values, thereby focusing the camera.

16. The storage medium according to claim 15, wherein the processor-executable instruction is further configured to cause, prior to the judging:
presetting and storing the correspondence table of distances between the distance sensor and the object to be shot and associated micro-adjustment ranges of the motor.

17. The storage medium according to claim 15, wherein the processor-executable instruction is further configured to cause:
controlling the motor to keep still at a current position in response to the judging that the current distance is equal to the initial distance.

18. The storage medium according to claim 15, wherein the processor-executable instruction is further configured to cause the collecting of the images in a real-time manner.

19. The storage medium according to claim 15, wherein the processor-executable instruction is further configured so that the acquiring of the focus values comprises:
acquiring and storing the focus values of the images when the motor moves into the different positions within the target micro-adjustment range;
comparing all of the focus values, and acquiring the position corresponding to the largest focus value; and
controlling the motor to move to the position corresponding to the largest focus value of the focus values, thereby focusing the camera.

20. The system according to claim 10, wherein the collecting of the images from the camera is in a real-time manner.
